(19) United States
(12) Patent Application Publication
(10) Pub. No.: US 2025/0209347 A1
(43) Pub. Date: Jun. 26, 2025

(54) RE-TRAINING A MACHINE LEARNING MODEL IN REAL-TIME USING A FAST ALGORITHM

(71) Applicant: INTUIT INC., Mountain View, CA (US)

(72) Inventors: Ivelin Georgiev ANGELOV, Mountain View, CA (US); Ruobing LU, Mountain View, CA (US)

(21) Appl. No.: 18/390,359

(22) Filed: Dec. 20, 2023

(51) Int. Cl. G06N 5/022

(52) U.S. Cl. CPC G06N 5/022

(57) ABSTRACT

A method for re-training a machine learning model includes generating an embedding of an item of data associated with a user of a software application; storing the embedding of the item of data prior to a trigger event comprising a user action with respect to the item of data; obtaining data indicative of the trigger event during an online session for the user of the software application; retrieving the embedding of the item of data from the data store in response to obtaining the data indicative of the trigger event during the online session; generating updated training data for the machine learning model based, at least in part, on the embedding of the item of data and the user action with respect to the item of data; and providing the updated training data to a re-training algorithm configured to re-train the machine learning model in real-time model.

### INTRODUCTION

Aspects of the present disclosure relate to re-training a machine learning model in real-time as a user performs an action during an online session of a software application. More particularly, aspects of the present disclosure relate to using an online model learning service that obtains the action and facilitates re-training of the machine learning model in real-time using a fast algorithm.

### BACKGROUND

Every year millions of people around the world utilize software applications to assist with countless aspects of life. For instance, software applications may be used to assist a user (e.g., solopreneur) with workflow, specifically bookkeeping, by automatically predicting a category for a given financial transaction involving the user. In this manner, software applications may eliminate the need for the user to manually assign each of the transactions to a respective category.

Conventional machine learning frameworks for such software applications include an embedding model. The embedding model may receive labeled data (e.g., transactions that have been assigned a category by a user) for a plurality of different users and may embed the labeled data in an n-dimensional space such that embeddings of similarly labeled data (e.g., transactions) are close to one another within the n-dimensional space.

Conventional machine learning frameworks for such software applications may further include a machine learning model that is personalized for a given user of the software application. The machine learning model may be trained using training data (e.g., the labeled embeddings) generated by the embedding model. For example, the prediction model may be trained to automatically predict a label (e.g., category) for a financial transaction involving the user (e.g., solopreneur).

However, conventional machine learning frameworks do not provide for real-time re-training of the machine learning model in response to a trigger event, such as the user for whom the machine learning model is personalized changing the label (e.g., predicted category) for a transaction during an online session (e.g. while the user is logged into his or her account associated with the software application). Instead, conventional machine learning frameworks support re-training of the machine learning model at regular intervals, such as once a day. However, this lack of re-training the machine learning model in real-time during the online session means that the label for other transactions that are similar to the transaction for which the user changed the label will not be updated in real-time. As a result, the user may provide additional input during the online session to manually change the label for those other transactions. This additional input may lead to errors that may ultimately affect re-training of the machine learning model at the next regularly scheduled re-training and, as a result, may lead to the machine learning model generating inaccurate predictions that then require even further input by the user to re-train the machine learning to correct for those inaccurate predictions, which may result in an inefficient utilization of computing resources.

Accordingly, there is a need for techniques for real-time re-training of a machine learning model triggered by user actions occurring during the online session.

### BRIEF SUMMARY

Aspects and advantages of embodiments of the present disclosure will be set forth in part in the following description, or may be learned from the description, or may be learned through practice of the embodiments.

In an embodiment, a method includes: generating an embedding of an item of data associated with a user of a software application; storing the embedding of the item of data prior to a trigger event comprising a user action with respect to the item of data; obtaining data indicative of the trigger event during an online session for the user of the software application; retrieving the embedding of the item of data from the data store in response to obtaining the data indicative of the trigger event during the online session; generating updated training data for the machine learning model based, at least in part, on the embedding of the item of data and the user action with respect to the item of data; and providing the updated training data to a re-training algorithm configured to re-train the machine learning model in real-time model to generate a re-trained machine learning model.

Further embodiments include a non-transitory computer-readable storage medium storing instructions that, when executed by a computer system, cause the computer system to perform the method set forth above. Further embodiments include a system comprising at least one memory and at least one processor configured to perform the method set forth above.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example computing environment including components related to automated workflow configuration assistance according to embodiments of the present disclosure.

FIG. 2 depicts a process for re-training a machine learning model associated with a software application in real-time in response to a trigger event occurring while a user is interacting with the software application according to some embodiments of the present disclosure.

FIG. 3 depicts a user interface updating with predictions output by a re-trained machine learning model according to some embodiments of the present disclosure.

FIG. 4 depicts a flow diagram of a process for re-training a trained machine learning model in real-time in response to a trigger event occurring while a user is interacting with a software application associated with the trained machine learning model according to some embodiments of the present disclosure.

FIGS. 5A and 5B depict example processing systems related to real-time re-training of a machine learning model according to embodiments of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure relate to re-training a machine learning model in real-time whenever a user performs an action with respect to an item of data during an online session for a software application.

Techniques disclosed herein include using an online model learning service that triggers real-time re-training of the machine learning model every time a user performs an action (e.g., during the online session for the software application) with respect to an item of data associated with the user. For example, the item of data may include a transaction involving the user, and the action may include the user manually assigning a label (e.g., category) to the transaction or, alternatively, manually changing a previously assigned label for the transaction so that the transaction now has a different label.

In response to the user action with respect to the item of data, the online model learning service may retrieve a pre-computed embedding of the item of data from a data store. The online model learning service may also obtain pre-computed embeddings of other items of data from the data store and for which the user manually assigned or changed a label for during the present online session or a prior online session. The online model service may then generate updated training data for the machine learning model based, at least in part, on the pre-computed embeddings and provide the updated training data to the fast re-training algorithm. The pre-computed embeddings allow the fast re-training algorithm to more quickly re-train the machine learning model as the fast re-training algorithm does not expend time and computational resources generating the embeddings since they are generated prior to the trigger event (e.g. the user action with respect to the item of data).

The fast re-training algorithm may include any suitable machine learning algorithm that facilitates re-training of the machine learning model in real-time. For example, the fast algorithm may include a regression algorithm. Examples of the regression algorithm may include, without limitation, a linear regression algorithm, a logistical regression algorithm, or a k-nearest neighbors algorithm. In some embodiments, the fast algorithm may facilitate re-training of the machine learning model in about 200 milliseconds. As used herein, use of the term “about” refers to a range of values without about 20 percent of the stated numerical value.

Once the machine learning model has been re-trained in real-time using the fast re-training algorithm, the re-trained machine learning model may output one or more predictions. As an example, embeddings for unlabeled data received while the user is offline (e.g, not logged into his or her account associated with the software application) or during the online session for the user may be provided as features to the re-trained machine learning model. In this manner, the re-trained machine learning model may predict labels for the unlabeled data during the online session. In some embodiments, the embeddings for the unlabeled data may be generated as each item of unlabeled data becomes available (e.g., an embedding of each transaction may be generated and stored at or near a time that the transaction is first received by the software application and/or otherwise in advance of receiving new or corrected labels and/or performing training or re-training of the machine learning model). Thus, by pre-computing and storing the embeddings for the unlabeled data, these embeddings may be available to efficiently retrieve and use as training data whenever new or corrected labels become available without the need to generate the embeddings at the time the labels are received or otherwise at training (or re-training) time. Accordingly, real-time re-training of the machine learning model may be performed in a more resource-efficient manner.

Example aspects of the present disclosure provide numerous technical effects and benefits. For instance, using an online model learning service to facilitate real-time re-training of the machine learning model every time a user performs an action with respect to an item of data during an online session ensures the machine learning model is as at accurate as possible at all times. In particular, machine learning models that are re-trained in real-time using the fast algorithm have improved performance (e.g., are more accurate) compared to conventional machine learning models that are re-trained in batch at regular intervals, such as once a day. Furthermore, re-training the machine learning model with updated training data that includes pre-computed embeddings allows the fast re-training algorithm (e.g., linear, logistical, k-nearest neighbor) to re-train the machine learning model in real-time and therefore minimizes time and computing resources needed to re-train the machine learning model.

### Example Computing Environment for Implementing a Software Application Using Machine Learning Techniques

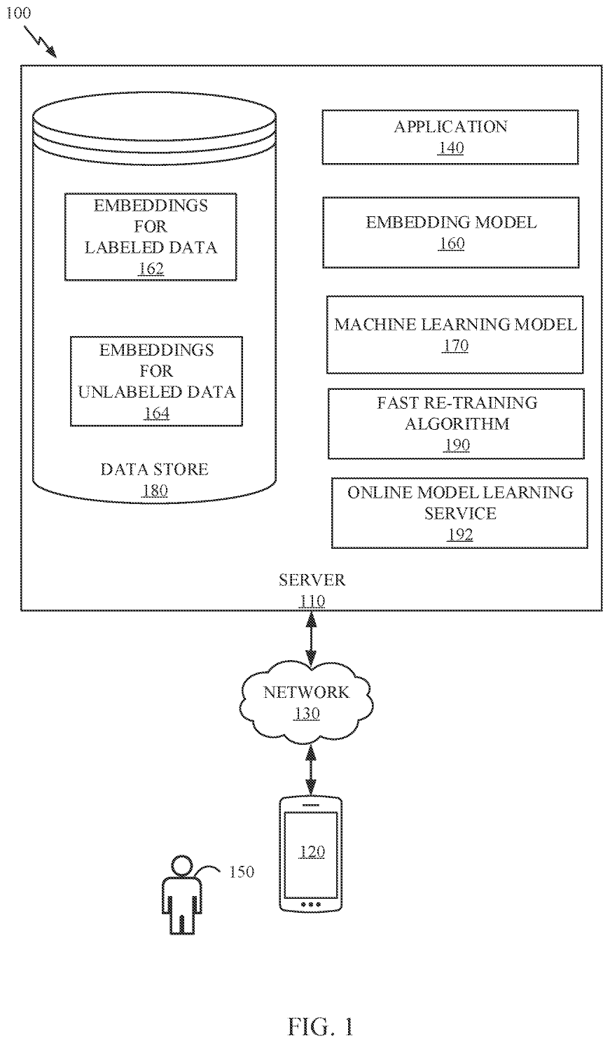

FIG. 1 illustrates an example computing environment 100 for real-time re-training of personalized machine learning models that predict labels for items of data (e.g., transactions) according to some embodiments of the present disclosure.

The computing environment 100 includes a server 110 and a client 120 connected over a network 130. The network 130 may be representative of any type of connection over which data may be transmitted, such as a wide area network (WAN), local area network (LAN), cellular data network, and/or the like.

The server 110 includes an application 140, which generally represents a computing application that users interact with over the network 130 via computing devices (e.g., a user 150 may interact with application 140 via the client 120). For example, in some embodiments, the application 140 may be accessed via a user interface displayed by the client 120.

In some embodiments, the application 140 may be an electronic financial accounting system that assists users in book-keeping or other financial accounting practices. For instance, the application 140 may assist the user 150 with book-keeping for financial transactions involving the user 150 and different vendors (e.g., payees). In some embodiments, the application 140 may be a standalone system. In alternative embodiments, the application 140 may be integrated with other software or service products provided by a service provider.

The computing environment 100 may include an embedding model 160. Labeled training data may be used to generate embeddings (e.g., labeled embeddings 162) that can then be used to train a machine learning model 170 to output predictions (e.g., a predicted classification for a given transaction). In some embodiments, the labeled training data may include historical transactions involving a plurality of different users of the application 140. In addition, the labeled training data may include a label for each of the historical transactions, and each label may be representative of an assigned category for a respective historical transaction. In this manner, the labeled training data may be used to train the machine learning model 170 to automatically predict a category for a given transaction.

In some embodiments, the labeled training data, which includes the labeled embeddings 162, may be used to train the machine learning model 170 through a supervised learning process. The supervised learning process may include providing training inputs (e.g., labeled embeddings 162) as inputs to the machine learning model 170. The machine learning model 170 may process the training inputs and output predictions (e.g., a predicted category for a transaction). In some embodiments, the output prediction may include a confidence score indicating a level of confidence that a given transaction falls within the predicted classification. The predictions are compared to the known labels associated with the training inputs (e.g., a binary label indicating how such a transaction has historically been categorized) to determine the accuracy of the machine learning model 170, and parameters of the machine learning model 170 are iteratively adjusted until one or more conditions are met. For instance, the one or more conditions may relate to an objective function (e.g., a cost function or a loss function) for optimizing one or more variables (e.g., model accuracy, model precision, model recall and/or the like). In some embodiments, the conditions may relate to whether the predictions produced by the machine learning model 170 based on the training inputs match the known labels associated with the training inputs or whether a measure of error between training iterations is not decreasing or not decreasing more than a threshold amount. The conditions may also include whether a training iteration limit has been reached. Parameters adjusted during training may include, for example, hyperparameters, values related to numbers of iterations, weights, functions used by nodes to calculate scores, and the like. In some embodiments, validation and testing are also performed for a machine learning model, such as based on validation data and test data, as is known in the art.

After the machine learning model 170 is trained, the embedding model 160 may continue to obtain additional data that, in contrast to the training data, does not include labels (e.g., categories). The embedding model 160 may be configured to embed the additional data (e.g., as unlabeled embeddings 164) in the n-dimensional space such that unlabeled embeddings for similar data are close to one another in the n-dimensional space.

In some embodiments, the computing environment 100 may include a data store 180 configured to store embeddings (e.g., labeled embeddings 162 and unlabeled embeddings 164) generated by the embedding model 160. Furthermore, in some embodiments, the data store 180 may store the label associated with each respective embedding of the labeled embeddings 162. It should be appreciated that the data store 180 may include any suitable memory device configured to store such data.

The computing environment 100 may include a fast re-training algorithm 190 and an online model learning service 192. As will now be discussed in more detail, the online model learning service 192 may work in conjunction with the fast re-training algorithm 190 to facilitate real-time re-training of the machine learning model 170 every time a user performs an action with respect to an item of data while interacting with a user interface (e.g., displayed on the client 120) of the application 140. In this manner, the machine learning model 170 can always be as accurate as it can possibly be and can therefore be improved (e.g, more accurate at all times) compared to conventional machine learning models that are re-trained in batch at regular intervals, such as once a day, as opposed to real-time.

### Real-Time Re-Training of a Machine Learning Model in Response to a Trigger Event

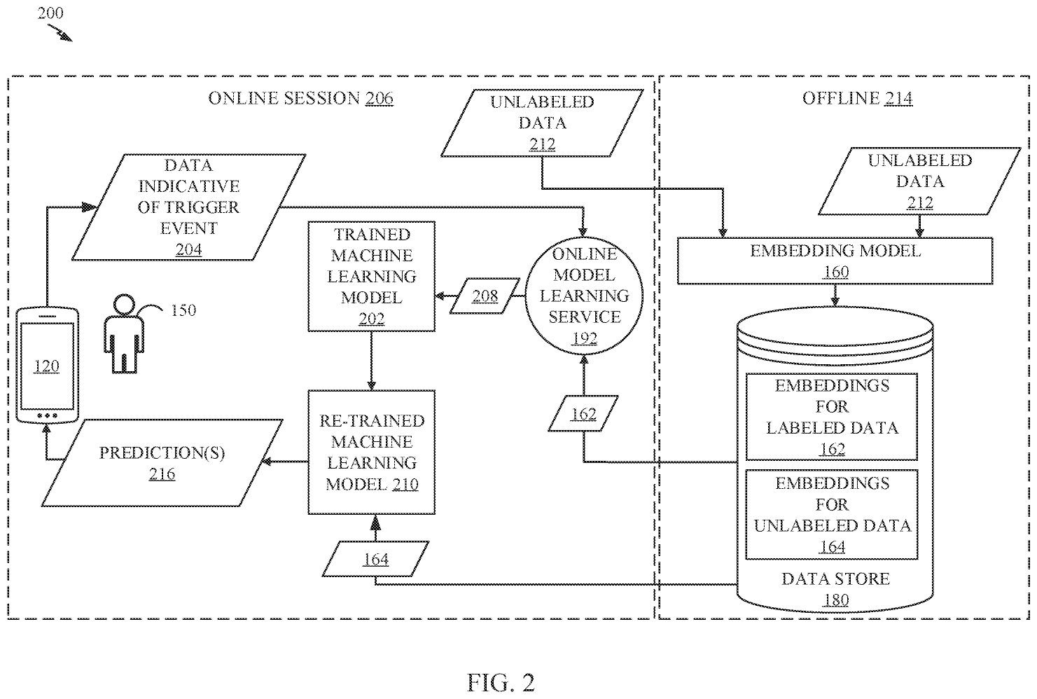

FIG. 2 illustrates a process 200 for re-training a trained machine learning model 202 (such as the machine learning model 170 in FIG. 1) associated with a software application (such as the application 140 in FIG. 1) in real-time in response to a trigger event occurring during an online session 206 for a user of the software application according to some embodiments of the present disclosure. For simplicity, the process 200 will be discussed in the context of the computing environment 100 discussed above with reference to FIG. 1.

As shown, data 204 indicative of a trigger event that occurs during the online session 206 for the user 150 of the application 140 (FIG. 1) may be generated every time a user performs an action (e.g., user input) during the online session 206 and with respect to an item of data (e.g., transaction) associated with the user 150. It should be appreciated that the online session 206 begins when the user 150 successfully logs into his or her unique account associated with the application 140 by entering his or her credentials (e.g., username and/or password) at a logon page of a user interface associated with the application 140 and displayed on the client 120.

In some embodiments, the action performed by the user 150 during the online session 206 may include the user 150 changing the label (e.g., category) for an item of data (e.g., transaction) depicted in the user interface (e.g., a “for review” page of the user interface) displayed on the client 120 during the online session 206. It should be appreciated, however, that the scope of the present disclosure is not intended to be limited to this specific trigger event and may therefore include other types of trigger events that may occur during the online session 206.

The data 204 indicative of the trigger event may be received by the online model learning service 192 configured to perform one or more steps needed to re-train the trained machine learning model 202 during the online session 206. In some embodiments, the trained machine learning model 202 may include the online model learning service 192. In alternative embodiments, the online model learning service may be standalone (e.g., separate from the trained machine learning model 202).

The online model learning service 192 may (e.g., in response to obtaining the data 204) update the label for the item of data that the user 150 changed during the online session 206. In addition, the online model learning service 192 may retrieve a previously generated embedding for the item of data from the data store 180. The online model learning service 192 may associate the updated label for the item of data with the previously generated embedding for the item of data. Furthermore, the online model learning service 192 may generate updated training data 208 based, at least in part, on the updated label for the item of data and the previously generated embedding representative of the item of data. In addition, the updated training data 208 may include other pre-computed embeddings included in the labeled embeddings 162 (along with their associated labels) and representative of items of data that the user 150 previously labeled.

The updated training data 208 may be provided to the fast re-training algorithm 190 (FIG. 1) to facilitate real-time re-training of the trained machine learning model 202 to generate a re-trained machine learning model 210 during the online session 206. In some embodiments, the pre-computed embeddings may be provided as a feature to the fast re-training algorithm 190. For instance, the pre-computed embedding retrieved from the data store 180 and representative of the item of data associated with the trigger event may be provided as a feature to the fast re-training algorithm 190. In addition, the pre-computed embeddings representative of other items of data that the user 150 previously labeled or updated the label for may also be provided as a feature to the fast re-training algorithm 190.

It should be appreciated that the fast re-training algorithm 190 may include any suitable machine learning algorithm. For instance, in some embodiments, the fast re-training algorithm 190 may include a regression algorithm, such as a linear regression algorithm. In alternative embodiments, the fast re-training algorithm 190 may be a logistical regression algorithm. Still further, in some embodiments, the fast re-training algorithm 190 may be a k-nearest neighbor algorithm.

As shown, the embedding model 160 may receive unlabeled data 212 (e.g., uncategorized transactions). For instance, the embedding model 160 may receive the unlabeled data 212 while the user 150 is offline 214 (e.g., not logged into his or her account associated with the application 140). The embedding model 160 may also receive the unlabeled data 212 during the online session 206. More specifically, the embedding model 160 may receive the unlabeled data 212 after the user 150 has logged into his or her unique account associated with the application 140 to begin the online session 206 but before the user 150 has logged out of his or her unique account to end the online session 206.

In contrast to embedding models used in conventional machine learning frameworks for such applications, the embedding model 160 according to the present disclosure is not limited to generating the unlabeled embeddings 164 for the unlabeled data 212 in response to a specific trigger event, such as the user 150 initiating the online session 206 by entering his or her credentials to logon to his or her unique account associated with the application 140. Instead, the embedding model 160 according to the present disclosure may generate the unlabeled embeddings 164 in real-time as the embedding model 160 ingests the unlabeled data 212 or, alternatively, may generate the unlabeled embeddings 164 in batch (e.g., once a day).

In some embodiments, the re-trained machine learning model 210 may output predictions 216 that may be provided to the client 120 for viewing by the user 150 during the online session 206. For instance, the user interface (e.g., the “for review” page thereof) associated with the application 140 and displayed on the client 120 may be updated to include the predictions 216. In some embodiments, the predictions 216 may include a predicted category for the unlabeled data 212. Alternatively, or additionally, the predictions 216 may include updated labels for one or more previously categorized items of data that are similar to the item of data for which the user 150 changed the label and, as a result, have also been relabeled.

It should be appreciated that re-training the trained machine learning model 202 in real-time in response to the trigger event (e.g., the user 150 changing the label for one or more transactions) to generate the re-trained machine learning model 210 during the online session 206 ensures the machine learning model is always as accurate as it can be. Furthermore, automatically updating the label for items of data that are similar to the item of data for which the user 150 changed the label may conserve computing resources as a computing system implementing the process will not need to process user input associated with the user 150 interacting with the user interface to manually change the labels for those items of data.

### Example User Interface Displaying Predictions Generated by Machine Learning Model Re-Trained in Real-Time in Response to a Trigger Event

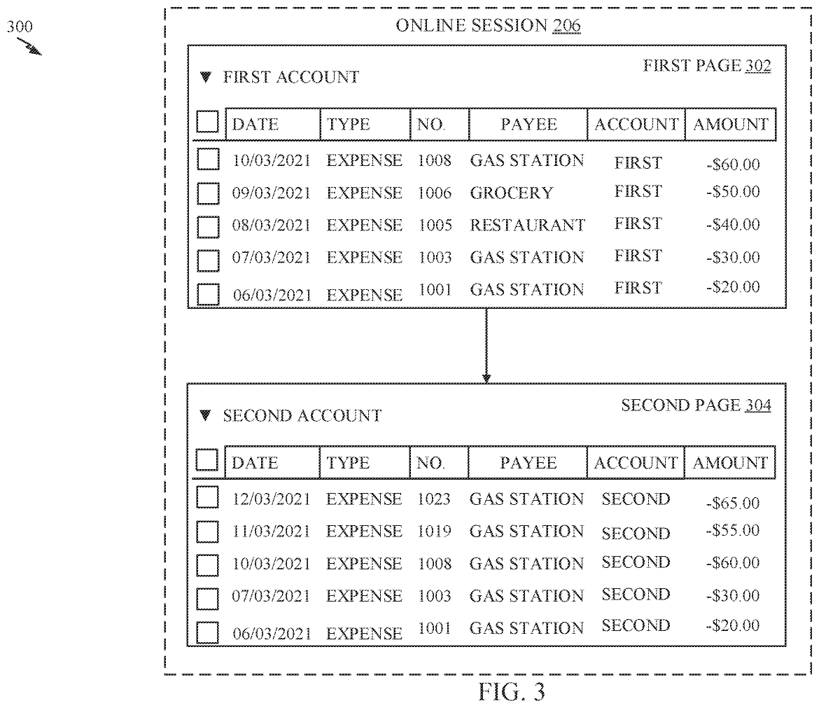

FIG. 3 depicts a user interface 300 associated with a software application updating with predictions generated by a re-trained machine learning model according to some embodiments of the present disclosure.

The user interface 300 may include a first page 302 displaying a list of items of data (e.g., transactions) categorized (e.g., labeled) to a first account associated with a user (such as the user 150 in FIG. 2) of the software application during the online session 206 (FIG. 2). While viewing the first page 302 of the user interface 300, the user may provide user input (e.g., via user interface elements associated with the user interface 300) to change the label (e.g., account) for a first item of data (e.g., the Oct. 3, 2021 transaction) with a particular vendor (e.g., gas station) included in the list of transactions. In particular, the user may change the label for the first item of data from “FIRST” to “SECOND” to re-categorize the first item of data to a second account that is also associated with the user and is different from the first account in which the first item of data is currently categorized.

The user input to change the label for the first item of data may trigger real-time re-training of a trained machine learning model (such as the trained machine learning model 202 in FIG. 2) associated with the software application. For instance, data (such as the data 204 in FIG. 2) indicative of the user input to change the label for the first item of data may be provided to an online model learning service (such as the online model learning service 192 in FIG. 2) associated with the software application. The online model learning service may facilitate re-training of a trained machine learning (such as the trained machine learning model 202 in FIG. 2) in real-time based on the changed label (e.g., from “FIRST” account to “SECOND” account) for the first item of data to generate a re-trained machine learning model (such as the re-trained machine learning model 210 in FIG. 2.

The re-trained machine learning model may automatically update the label for other items of data categorized in the first account that are similar (e.g., involve the same vendor) to the first item of data for which the user changed the label and, as a result, now need to be re-categorized. For example, the re-trained machine learning model may automatically update the label for a second item of data (e.g., the Jul. 3, 2021 transaction with the gas station) and a third item of data (e.g., the Jun. 3, 2021 transaction with the gas station) included in the list of transactions categorized as being in the first account.

The re-trained machine learning model may also predict labels for unlabeled items of data. For example, the re-trained machine learning model receive unlabeled embeddings (such as the unlabeled embeddings 164 in FIG. 2) from an embedding model (such as the embedding model 160 in FIG. 2). As an example, a first unlabeled embedding and a second unlabeled embedding that are representative of respective items of data (e.g, transactions) involving the user and the gas station. The re-trained machine learning model may predict a label for each of the first and second unlabeled embeddings. More specifically, the re-trained machine learning model may label the first and second unlabeled embeddings as being in the second account given that both embeddings are representative of items of data involving a specific vendor (e.g., gas station) and for which the user just updated the label.

As shown, the user interface 300 may include a second page 304 displaying a list of items of data included in the second account. For instance, the second page 304 of the user interface 300 may include the first item of data (e.g., the Oct. 3, 2021 transaction with the gas station) that was previously categorized in the first account and was then re-categorized to the second account as a result of input provided by the user during the online session 206.

The second page 304 of the user interface 300 may also be automatically populated with the predictions generated by the re-trained machine learning model. For instance, the second page 304 may include the second item of data (e.g., the Jul. 3, 2021 transaction with the gas station) and the third item of data (e.g., the Jun. 3, 2021 transaction with the gas station) that were previously categorized in the first account and that the re-trained machine learning model automatically predicted needed to be re-categorized to the second account based, at least in part, on the user input changing the label for a similar item of data (that is, the first item of data) to the second account.

The second page 304 of the user interface 300 may also be automatically populated with items of data that were previously unlabeled but that the re-trained machine learning model predicted need to be categorized in the second account. For instance, the second page 304 of the user interface 300 may include a fourth item of data (e.g., the Nov. 3, 2021 transaction with the gas station) and a fifth item of data (e.g., the Dec. 3, 2021 transaction) that the re-trained machine learning model automatically predicted need to be categorized in the second account.

### Example Method for Real-Time Re-Training of a Machine Learning Model Associated with a Software Application in Response to a Trigger Event

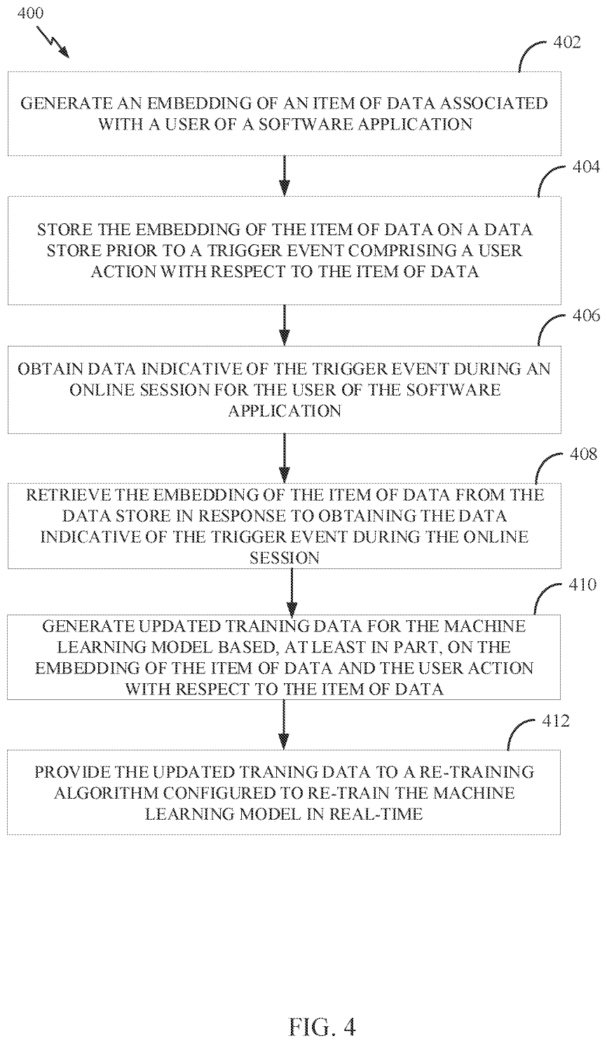

FIG. 4 depicts example operations 400 related to automated real-time re-training of a machine learning model associated with a software application according to embodiments of the present disclosure. For example, the operations 400 may be performed by one or more components described above with respect to computing environment 100 of FIG. 1.

Operation 402 includes generating an embedding of an item of data associated with a user of a software application. For example, the item of data may include a transaction involving the user. In some embodiments, the embedding of the transaction may be generated in real-time or near real-time as the transaction is received by the software application.

Operation 404 includes storing the embedding of the item of data on a data store prior to a trigger event including a user action with respect to the item of data. For example, the data store may be a database configured to store the embedding of the item of data as well as embeddings for other items of data (e.g., transactions) associated with the user. Furthermore, the user action may occur during an online session for the software application and may include the user assigning a label for the item of data or, alternatively, changing a previously assigned label for the item of data.

Operation 406 includes obtaining data indicative of the trigger event during an online session for the user of the trigger event. For example, the data may be indicative of the user assigning a label to the item of data or, alternatively, changing a previously assigned label for the item of data.

Operation 408 includes retrieving the embedding of the item of data from the data store in response to operation 406. More particularly, the embedding of the item of data may be retrieved in response to the user manually assigning a label for the item of data or, alternatively, manually changing a label for the item of data from a first label (e.g., first category) to a second label (e.g., second category).

Operation 410 includes generating updated training data for the machine learning model based, at least in part, on the embedding of the item of data and the user action with respect to the item of data. For example, the

Operation 412 includes providing the updated training data to a fast re-training algorithm configured to re-train the machine learning model in real-time. The updated training data provided to the fast re-training algorithm may include the pre-computed embedding representative of the item of data associated with the trigger event detected at operation 406. In addition, the updated training may include pre-computed embeddings for other items of data associated with prior actions performed by the user. By providing pre-computed embeddings to the fast re-training algorithm, an amount of time needed to re-train the machine learning model since embeddings are already generated for the fast re-training algorithm.

In some embodiments, operations 400 may include obtaining one or more predictions generated by the re-trained machine learning model during the online session. For instance, the one or more predictions may include an updated label for one or more items of data that were affected by the user action (e.g., changed label, assigned label) with respect to the item of data at operation 406. For example, a user action with respect to a label for a first item of data may affect a label for a second item of data, and the re-trained machine learning model may output a new label (e.g., prediction) for the second item of data based, at least in part, on the re-training.

In some embodiments, operations 400 may include automatically updating the user interface during the online session to display the one or more predictions generated by the re-trained machine learning model. For example, the one or more predictions may include an updated label for a second item of data affected by the user changing the label for a first item of data. Therefore, the user interface may be automatically updated to reflect the updated label for the second item of data. Alternatively, or additionally, the user interface may be automatically updated to include a predicted label for an unlabeled transaction that was not previously displayed on the user interface.

### Example Computing Systems

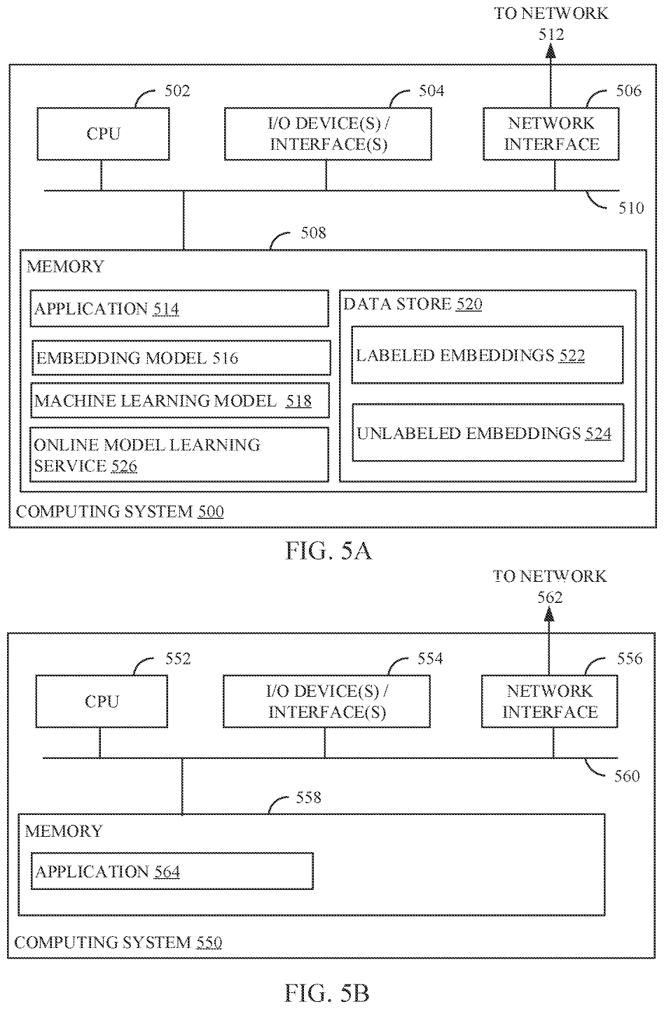

FIG. 5A illustrates an example computing system 500 with which embodiments of the disclosure related to real-time re-training of a trained machine learning model may be implemented. For example, the computing system 500 may be representative of the server 110 of FIG. 1.

The computing system 500 includes a central processing unit (CPU) 502, one or more I/O device interfaces 504 that may allow for the connection of various I/O devices 504 (e.g., keyboards, displays, mouse devices, pen input, etc.) to the computing system 500, a network interface 506, a memory 508, and an interconnect 510. It is contemplated that one or more components of the computing system 500 may be located remotely and accessed via a network 512. It is further contemplated that one or more components of the computing system 500 may include physical components or virtualized components.

The CPU 502 may retrieve and execute programming instructions stored in the memory 508. Similarly, the CPU 502 may retrieve and store application data residing in the memory 508. The interconnect 510 transmits programming instructions and application data, among the CPU 502, the I/O device interface 504, the network interface 506, the memory 508. The CPU 502 is included to be representative of a single CPU, multiple CPUs, a single CPU having multiple processing cores, and other arrangements.

Additionally, the memory 508 is included to be representative of a random access memory or the like. In some embodiments, the memory 508 may include a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, the memory 508 includes application 514, embedding model 516, and machine learning model 518, which may be represents of the application 140, embedding model 160, and machine learning model 170 of FIG. 1. The memory 508 may further include a data store 520, which may be representative of the data store 180 of FIG. 1. The data store 520 may include labeled embeddings 522 and unlabeled embeddings 524, which may be representative of the labeled embeddings 162 and unlabeled embeddings 164 of FIG. 1. The memory 508 may also include an online model learning service 526, which may be representative of the online model learning service 192 of FIG. 2.

FIG. 5B illustrates an example computing system 550 with which embodiments of the system for allowing a user to interact with a software application to trigger real-time re-training of a machine learning model associated with the software application. For example, the computing system 550 may be representative of the client 120 of FIG. 1.

The computing system 550 includes a central processing unit (CPU) 552, one or more I/O device interfaces 654 that may allow for the connection of various I/O devices 554 (e.g., keyboards, displays, mouse devices, pen input, etc.) to the computing system 550, a network interface 556, a memory 558, and an interconnect 560. It is contemplated that one or more components of the computing system 550 may be located remotely and accessed via a network 562. It is further contemplated that one or more components of the computing system 550 may include physical components or virtualized components.

The CPU 552 may retrieve and execute programming instructions stored in the memory 558. Similarly, the CPU 552 may retrieve and store application data residing in the memory 558. The interconnect 560 transmits programming instructions and application data, among the CPU 552, the I/O device interface 554, the network interface 556, the memory 558. The CPU 552 is included to be representative of a single CPU, multiple CPUs, a single CPU having multiple processing cores, and other arrangements.

Additionally, the memory 558 is included to be representative of a random access memory or the like. In some embodiments, the memory 558 may include a disk drive, solid state drive, or a collection of storage devices distributed across multiple storage systems. Although shown as a single unit, the memory 558 may be a combination of fixed and/or removable storage devices, such as fixed disc drives, removable memory cards or optical storage, network attached storage (NAS), or a storage area-network (SAN).

As shown, the memory 558 may include an application 564, such as a user-side application (e.g., comprising a user interface) discussed above with respect to client 120 of FIG. 1.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for re-training a machine learning model in real-time, comprising:
generating an embedding of an item of data associated with a user of a software application;
storing the embedding of the item of data on a data store prior to a trigger event comprising a user action with respect to the item of data;
obtaining data indicative of the trigger event during an online session for the user of the software application;
retrieving the embedding of the item of data from the data store in response to obtaining the data indicative of the trigger event during the online session;
generating updated training data for the machine learning model based, at least in part, on the embedding of the item of data and the user action with respect to the item of data; and
providing the updated training data to a re-training algorithm configured to re-train the machine learning model in real-time to generate a re-trained machine learning model.

2. The method of claim 1, wherein generating the embedding of the item of data comprises generating the embedding during the online session for the user of the software application.

3. The method of claim 1, wherein generating the embedding of the item of data comprises generating embedding before the online session for the user of the software application.

4. The method of claim 1, wherein providing the updated training data to the re-training algorithm comprises providing the embedding of the item of data as a feature for the re-training algorithm.

5. The method of claim 1, further comprising:
obtaining one or more predictions generated by the re-trained machine learning model, wherein the one or more predictions comprise a predicted label for an unlabeled item of data associated with the user.

6. The method of claim 5, wherein obtaining the one or more predictions generated by the re-trained machine learning model during the online session comprises:
providing an embedding generated for the unlabeled item of data before the online session or during the online session as a feature to the re-trained machine learning model; and
obtaining a predicted label for the unlabeled item of data as an output of the re-trained machine learning model during the online session.

7. The method of claim 5, further comprising:
updating a user interface of the software application during the online session to display the one or more predictions generated by the re-trained machine learning model.

8. The method of claim 1, wherein providing the updated training data to a re-training algorithm comprises providing the updated training data to a regression algorithm configured to re-train the machine learning model in real-time to generate the re-trained machine learning model.

9. A system for re-training a machine learning model in real-time, the system comprising:
a memory including computer executable instructions; and
a processor configured to execute the computer executable instructions and cause the system to:
generate an embedding of an item of data associated with a user of a software application;
store the embedding of the item of data on a data store prior to a trigger event comprising a user action with respect to the item of data;
obtain data indicative of the trigger event during an online session for the user of the software application;
retrieve the embedding of the item of data from the data store in response to obtaining the data indicative of the trigger event during the online session;
generate updated training data for the machine learning model based, at least in part, on the embedding of the item of data and the user action with respect to the item of data; and
provide the updated training data to a re-training algorithm configured to re-train the machine learning model in real-time to generate a re-trained machine learning model.

10. The system of claim 9, wherein to generate the embedding of the item of data, the computer executable instructions cause the processor to generate the embedding during the online session for the user of the software application.

11. The system of claim 9, wherein to generate the embedding of the item of data, the computer executable instructions cause the processor to generate the embedding before the online session for the user of the software application.

12. The system of claim 9, wherein to provide the updated training data to the re-training algorithm, the computer executable instructions cause the processor to provide the embedding of the item of data as a feature for the re-training algorithm.

13. The system of claim 9, wherein the computer executable instructions further cause the processor to:
obtain one or more predictions generated by the re-trained machine learning model, wherein the one or more predictions comprise a predicted label for an unlabeled item of data associated with the user.

14. The system of claim 13, wherein to obtain the one or more predictions generated by the re-trained machine learning model, the computer executable instructions cause the processor to:
provide an embedding generated for the unlabeled item of data before the online session or during the online session as a feature to the re-trained machine learning model; and
obtain a predicted label for the unlabeled item of data as an output of the re-trained machine learning model during the online session.

15. The system of claim 13, wherein the computer executable instructions further cause the processor to:
update a user interface of the software application during the online session to display the predicted label generated by the re-trained machine learning model.

16. The system of claim 9, wherein the re-training algorithm comprises a regression algorithm.

17. The system of claim 16, wherein the regression algorithm comprises a linear regression algorithm or a logistical regression algorithm.

18. The system of claim 9, wherein the re-training algorithm is configured to re-train the machine learning model is less than 200 milliseconds.

19. A non-transitory computer readable medium comprising instructions to be executed in a computer system to re-train a machine learning model in real-time, wherein the instructions when executed in the computer system cause the computer system to:
generate an embedding of an item of data associated with a user of a software application;
store the embedding of the item of data on a data store prior to a trigger event comprising a user action with respect to the item of data;
obtain data indicative of the trigger event during an online session for the user of the software application;
retrieve the embedding of the item of data from the data store in response to obtaining the data indicative of the trigger event during the online session;
generate updated training data for the machine learning model based, at least in part, on the embedding of the item of data and the user action with respect to the item of data; and
provide the updated training data to a re-training algorithm configured to re-train the machine learning model in real-time to generate a re-trained machine learning model.

20. The non-transitory computer readable medium of claim 19, wherein the embedding of the item of data is generated before the online session for the user of the software application.
